(19) United States
(12) Patent Application Publication
(10) Pub. No.: US 2015/0166320 A1
(43) Pub. Date: Jun. 18, 2015

(54) CONSTANT HEAD GRAVITY FLUID DISPENSER

(71) Applicant: SIAWOR CHRISTIAN SELORM KWADWO, (US)

(72) Inventor: Christian Selorm Kwadwo Siawor, Accra (GH)

(21) Appl. No.: 14/411,899

(22) PCT Filed: Jul. 4, 2013
(86) PCT No.: PCT/GH2013/000001

§ 371 Date: Dec. 29, 2014

(30) Foreign Application Priority Data
Jul. 6, 2012 (GH) GH/P/12/00017

(51) Int. Cl. C02F 1/00; B01D 35/027; B01D 29/66

(52) U.S. Cl. CPC B67D 3/0061; B01D 35/027; B01D 29/66

(57) ABSTRACT

This invention is a constant head gravity fluid dispenser that guarantees a constant preset condition of its internal float valve (16) mechanism by encasing it in a reservoir (1) and also shielding it with a back-washable filter unit (9) that respectively ensures its physical insulation from external influence and any potential blockage. However, all minute particles pass through the filter aggregate at a predetermined location within the system to be drained. The dispenser engages a float mechanism, valves of different sizes and a vent pipe (11) attached to the reservoir (1) to exhaust excess internal air pressure as the reservoir is being filled.

### FIELD OF INVENTION

The invention relates to a constant head gravity fluid dispenser.

### BACKGROUND

In the field of controlled dispensing, the rate of dispensing liquid is required to be precise and consistent with a rate control device used. Maintenance of the correlation between the rate of flow and the flow control device is to a great extent dependent on the stability of static pressure head of liquid in the dispenser. The degree of susceptibility of the head control mechanism of the dispenser away from its initial preset condition after maintenance and repairs works or during normal operation remains a key factor that influences the reliability of the equipment.

There is therefore a compelling need for an integrated approach with an adequate provision to insulate the float mechanism from the threat of collecting sediments that may require occasional physical cleaning intervention with the tendency to impact negatively on the initial preset condition.

Traditionally the housing for the float mechanism is occasionally accessible physically for cleaning of sediments which deposits over time and also during maintenance. The afore-mentioned activity has the tendency to compromise the float mechanism with consequential impact on the preset condition that defines the status of the static head.

### GENERAL DESCRIPTION

The preferred embodiment of the secured constant head gravity dispensing system comprise of a cuboid shaped reservoir housing a float device (static head control mechanism), a back-washable filtration unit mounted on top of the reservoir and connected to an inlet side of the reservoir by means of two elbows joint together. There are five other flow regulating valves three on the filter unit and two on the dispensing reservoir.

The filter unit is one part of the system embodiment that ensures that the inlet of the float valve is not clogged and also guarantees that the quality of liquid being dispensed from the reservoir is uniform and to conform to the grade of sieve selected.

The stability of the preset static head of liquid in the dispensing reservoir also guarantees a constant flow rate at a particular setting on the dispensing flow regulator which is perfected by maintaining the internal and external preset conditions. This has been achieved by means of the back-washable filter unit fitted with up-wash water facility and waste drain valve thus shielding the internal mechanism by ensuring that the system is not clogged by particles and grits to cause intermittent head loss. Secondly the external condition is stabilized by means of securing the entire system with bolts and nuts for mounting.

The float is hinged to the inlet valve by means of a rod projecting along a horizontal plane. The float rises to reduce inflow into the system during the filling process and falls to increase the inflow of liquid into the reservoir during the draining process. The system has its inlet to the reservoir wider in diameter than the outlet valve diameter. This design ensures that any liquid that leaves the dispensing valve is immediately replaced to instantaneously compensate for any apparent head-loss.

Provision has been made by positioning a vent on top of the dispenser unit that ensures that there is no change in the internal head attributed to changes relative variation in both the internal and atmospheric air pressure.

The entire system is constructed mainly of stainless steel material which ensures a high degree of system integrity against defects attributable to rust, wear and tire. The system (dispensing unit and the filter unit) has been absolutely secured with practically no access to alter any of its internal members; this guarantees a constant operating head. All replaceable components (ball and gate valves) have been positioned outside and their maintenance or replacement will not affect the overall efficiency of system functionality.

Virtually all components including the filter unit, gate valves, tees and elbows are detachable though they constitute one complete system embodiment. They have been positioned outside the equipment for the ease of repair and replacement.

The general design of the dispensing units and arrangement of the entire system comprising the filter unit, valves and the dispensing reservoir guarantees an unimpeded flow of influent into the dispensing reservoir.

The design guarantees that suspended particles within the liquid is trapped by the filter and those that are smaller to pass through the filter unit will have no adverse impact on the system integrity than to gravitate by gliding gently on the sloppy base and accumulate around the concave section of the base from where it can be dislodge by turning on valve 3 in FIGS. 2 & 3. This arrangement ensures that quality of liquid dispensed is uniform in consistency

### DETAILED DESCRIPTION

This section will give a general description of the key system embodiment in respect of the dispensing system and the filter unit, and also describe the operation of the system through a schematized flow illustrating liquid movement from the inlet through the filter and outlet valve.

The description would be done under two main sections;
a) Outline description of dispensing system.
b) Filter unit
c) Description of external fittings and internal components on the dispensing system

a. Outline Description

The geometry of the dispensing system can generally be described as cuboid having the side profile represented by panel A and C in FIG. 1, identical in shape and dimension. The remaining planes are asymmetrical with a few irregular curved edges. The template as shown in FIG. 1 has been divided into panel categories for ease of description. The pattern is cut out along the outline according to a preferred dimension which may not be limited once the key components and geometry are maintained. Panels A and C are then folded at 90° in opposite directions to the plane labeled B1 such that A, B1 and C form a groove. The panels B2, B3 and B4 are then folded such that they respectively trace and interface the edges at their adjoining section of panels A and C.

A Panel plate represented in dimension by D4, D3, and D2 and D1 as in FIG. 1 is formed and placed such that the D4 plate is aligned to interface B4 whilst the remaining section are folded to cover the remaining opened section along the base. All opened sections are then welded thoroughly. A plate similar to item marked 15 in FIG. 1 is formed to cover the back of the dispenser reservoir and also to hold the float valve marked 16 in position.

An exterior piping projections of the float valve 16 is positioned such that its associated float rise to a level to shut off the valve within 16 to prevent further inflow of liquid when the content attain a preset level at an elevation which is higher than the level of the outlet piping marked 12 and 13 in FIG. 2, this guarantees a positive head at all times.

b. Filter Unit

FIG. 4 represents the transverse section of the filter. Generally the filter marked 9 in FIGS. 2 and 3 has an internal cylinder marked 27 in FIG. 4 which has several holes marked 22 drilled around it. The entire internal surface of 27 is covered with a pre-selected sieve of a known pore size depending on quality of liquid expected to be dispensed on one hand and also the protection offered to the valve and the entire system against blockage. The cylinder 27 is then guarded into position and centered within a larger cylinder 26 by 24 which form part of the internal structure 26 which has holes drilled around it to ensure efficiency during liquid flow in either direction. The inlet 21 and outlet 23 are respectively defined by 20 and 25 outlet.

c. Describing the External Fittings on the Dispensing Unit

Two male and female elbows marked 4 and 17 respectively in FIGS. 2 & 3 connect the float valve to a tee pipe marked 19 which is attached to the outlet end of the filter marked 9 in FIGS. 2 & 3 with the remaining free end connected to an up-wash flow control valve marked 10 in FIGS. 2 & 3. A second tee marked 8 in FIGS. 2 & 3 has one of its end attached to the inlet of the filter whiles its remaining free ends are each connected to valves marked 7 and 18 in FIGS. 2 & 3. These ball valves are respectfully engaged during back-washing of the filter. Attached to valve 7 in FIGS. 2 & 3 are 2 elbows marked 6 that defines the main inlet of the system.

At the center marked B3 in FIG. 1 is the point for locating the outlet valve marked 5 in FIG. 2. The valve 5 is the outlet valve controlling the amount of liquid being dispensed.

Item marked 3 in FIGS. 2 & 3 is the waste (slurry) disposal valve for exhausting any settled particles within the dispensing unit. A vent to exhaust excess air pressure within the dispensing reservoir and to bring it to the level of atmospheric pressure is positioned on top of the dispensing reservoir and marked 11 in FIGS. 1 & 2.

### System Operation

In normal operation, valves 18, 10 and 3 as shown in FIGS. 2 & 3 are turned off whilst valve 7 is opened. This allows the feed liquids enter at point 6 and flow along the route defined by the arrows in FIG. 2. The feed liquid flows through fixtures 7, 8, 9, 19, 17, 4 and 16 before entering the reservoir marked 1. As the feed liquid fills the reservoir the float rises till it attains a preset position where it pushes the valve in 16 to shut off preventing further inflow into 1.

During back-washing of the filter 9, valves 5 and 7 are turned sequentially off preventing the flow of feed liquid both out and into of the system. Valves 18 & 10 are opened sequentially to allow the up-wash water to flow mainly in the opposite direction to the flow of the feed liquid flushing out trapped particles through 18. The up-wash water flow from 10 through 19, 9, 8 and finally drains out through 18.

### DESCRIPTION OF DRAWINGS

The drawings itemized under FIG. 1, FIG. 2, FIG. 3, and FIG. 4 below is intended to help describe the system accordingly.

FIG. 1 represents the pattern from which the dispensing unit is constructed

FIG. 2 represents the entire embodiment of the system from the side view

FIG. 3 represents the entire embodiment of the system from the back view

FIG. 4 represents the filter design

1. A secured constant head gravity liquid dispenser system, comprising:
An encased dispensing reservoir with absolutely no means of physically accessing or tampering with its internal mechanism thus ensuring a constant internal preset condition;
An inlet piping and valve system;
A back-washable filtration unit operably attached to the dispensing reservoir;
A vent pipe operably fitted to the reservoir to serve as an exhaust pipe to equilibrate the internal air and atmospheric air pressures and to give an indication on the stability and the integrity of the internal mechanism;
An internal float mechanism which is completely encased by the dispensing reservoir;
A rod hinged onto the inlet valve unit at one end and supporting the float device at the other end moves freely up and down relative to the hinge point on the basis of the level of liquid in the reservoir;
A flow control valve attached to the outlet end of the filter unit which controls flow of fresh water through the filter in a reverse direction when filter is being back-washed;
An outlet waste valve attached to the filter which is engaged during back-washing of filter
A stand at the base of the dispensing unit purposely for affixing the system onto a platform for securing the external condition that has the tendency to influence the head.

2. The dispenser of claim 1, wherein the inlet piping, dispensing reservoir and filter unit although constitute one fused system are detachable.

3. The dispenser of claim 1, wherein the design of the lower planes of the dispensing reservoir slant gentling to allow for particles that aggregates (slurry) in the reservoir to gravitate and accumulate within a packet at the lowest point of the reservoir to be disposed of through and auxiliary valves attached to it.

4. The dispenser of claim 1, wherein; the inlet pipe, the filter unit and the dispenser unit are arranged such that it is progressively inclined at a gradient that ensures liquid flow under gravity is not compromised.

5. The dispenser of claim 1, wherein; the lower section of the front view is arc shaped resting under a horizontal plane projecting into the dispensing reservoir and above which the main variator is positioned. This arrangement provides a shield to the outlet by allowing build-up particles under the under the horizontal plan aforementioned to effectively glide backwards towards the slurry disposal valve (auxiliary valve) for their disposal.

6. The constant head gravity dispenser of claim 1, wherein; flow control valves are directly attached to both the inlet and outlet ends of the filtration unit.

7. The dispenser of claim 1, wherein a valve is attached to the base of the dispensing unit to exhaust any accumulated slurry or particles that goes through the filter unit and get settled at the base of the dispensing unit.

8. The dispenser of claim 1, wherein; the outlet valves (variator) and all other valves are positioned outside the system and can be detached and replaced with an end cap for the convenience of repair and replacement while the system maintains its functionality.

9. An inlet piping system of claim 1 wherein; the system is used to regulate the inflow and outflow of liquid through the filter during operations

10. The dispenser of claim 1, wherein; the system can be upgraded by changing the main dispensing valves and the efficiency of dispensing would not be compromised

11. The dispenser of claim 1 wherein; the system is secured with bolts and nuts.

12. The dispenser of claim 1, wherein a bulk liquid tank is connected to the filter inlet by a flexible hose.

13. The dispenser of claim 1, wherein; the entire system is mainly constructed of stainless steel material

14. The dispenser of claim 1, wherein; the base valve doubles as an auxiliary or emergency valve which can be engaged anytime the need arises to maintain or replace the outlet flow valve.

15. The dispenser of claim 1, wherein; the valve has numeric settings displayed on it to indicate the level of turns.

16. The dispenser claim 14, wherein; the valves on the filter system are of the same size ensures easy replacement with a new one if available or swapping the defective one with another functioning depending on its operational relevance and frequency or its engagement.

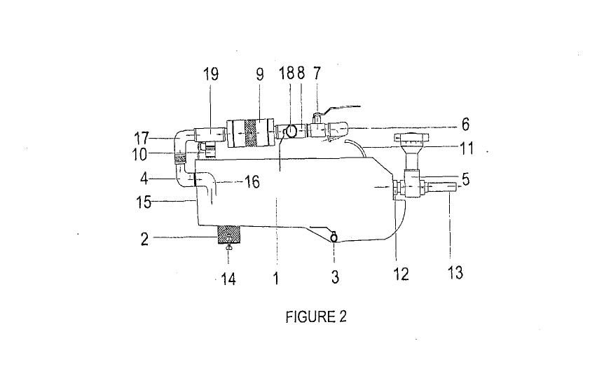

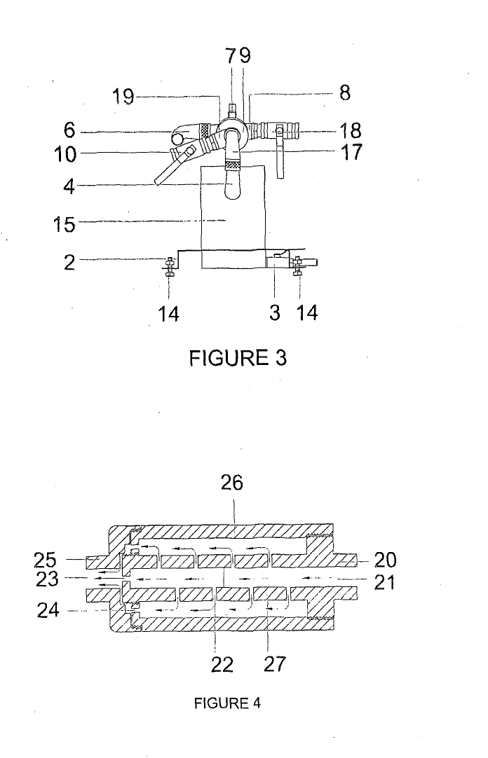

17. A method of operation a constant head gravity dispenser, the method comprising: the turning off valves 18, 10 and 3 in FIGS. 2 & 3 whilst opening valve 7 to allow the feed liquids enter at point 6 and flow along the route defined by the arrows in FIG. 2; Allowing the feed liquids to flow through fixtures 7, 8, 9, 19, 17, 4 and 16 before entering the reservoir marked 1 in FIG. 2 so that the feed liquids fill the reservoir and cause the float to rise till it attains a preset position where it pushes the valve in 16 to shut off preventing further inflow into 1.

18. The method of claim 17, wherein; the filter 9, valves 7 and 5 in FIG. 2 is back-washed by turning these fixtures off to prevent the flow of feed liquid both in and out of the system, by opening valves 18 and 10 sequentially to allow the up-wash water to flow mainly in the opposite direction of the flow of the feed liquid; Allowing the up-wash water to flow from 10 through 19, 9, 8 and finally to drain out of 18.

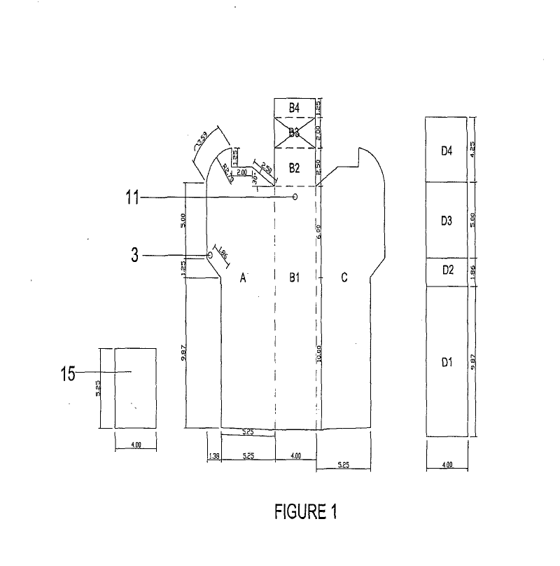

19. A method of constructing a cuboidal reservoir of a constant head gravity dispensing system, the method comprising: folding a panel of similar dimensions as in FIG. 1; folding the plane labeled A in FIG. 1 90° to plane B1 and plane C is also at 90° in the opposite direction such that A, B1 and C form a groove; folding B2, B3 and B4 in FIG. 1 such that they respectively trace and interface the edges at the adjoining section of panels A and C; molding and placing the panel plate represented by D4, D3, and D2 and D1 as in FIG. 1 such that D4 is aligned and interface B4 whilst folding the remaining section to cover the remaining opened section along the base; forming a plate similar to item marked 15 in FIG. 1 to cover the back of the dispenser reservoir and also to hold the float valve marked 16 in position; welding all opened sections thoroughly.
